(19) United States
(12) Patent Application Publication
(10) Pub. No.: US 2009/0138960 A1
(43) Pub. Date: May 28, 2009

(54) Control access rule conflict detection

(75) Inventors: Amy Felty, Ottawa (CA); Venanzio Capretta, Wijchen (NL); Bernard Stepien, Ottawa (CA); Stan Matwin, Ottawa (CA)

Correspondence Address: Ralph A. Dowell of DOWELL & DOWELL P.C., 2111 Eisenhower Ave, Suite 406, Alexandria, VA, 22314, US

(73) Assignee: UNIVERSITY OF OTTAWA, Ottawa (CA)

(21) Appl. No.: 12/289,342

(22) Filed: Oct. 24, 2008

Related U.S. Application Data
(60) Provisional application No. 60/996,080, filed on Oct. 26, 2007.

(51) Int. Cl. G06F 21/20; G06N 5/02

(52) U.S. Cl. 726/14; 706/48; 726/3

(57) ABSTRACT

Methods and systems for access control systems such as firewalls. The system detects conflicts between two access control rules by finding all common variables between the two rules and determining if there are values for all the common variables that simultaneously satisfy both rules. If there are such values, and if the end result of the two rules are different, then the two rules are in conflict with one another.

### RELATED APPLICATIONS

This application claims benefit of priority from U.S. Application 60/996,080 filed 26 Oct. 2007.

### TECHNICAL FIELD

The present invention relates to communications systems and, more specifically, relates to systems and methods for detecting conflicts between access control rules which may be used in access control systems that protect assets such as computer firewall applications, electronic documents, and other similar assets.

### BACKGROUND OF THE INVENTION

The worldwide proliferation of computer networks in the past decade has also led to an increase in concern regarding the security of these networks. One popular means by which network security has been enforced is the firewall. A firewall receives data packets from outside the network to be protected and, based on a set of predefined rules, determines if the data packets are to be allowed into the protected network or not.

While firewalls can be quite effective, a problem arises when the number of rules considered by the firewall increases. Due to the large number of possible rules that a firewall may need enforce, conflicts may arise between the rules. As an example, one rule may deny access to data packets coming from a specific source while another rule may allow access to the same packets.

However, rule conflicts is only one issue which may plague firewalls. Another issue is the ease, or lack thereof, with which these rules may be created. Rule creation usually entails not only an understanding of networks and programming languages.

The research on access control specification languages focuses on trying to resolve the antagonistic features of simplicity and complexity. Simple languages force the users to use convoluted techniques to reduce the number of rules and thus result in the users falling in a different domain of complexity. Complex languages cause users to shy away altogether because they require users to be highly skilled. This is a disadvantage in the context of high labor turnover or outsourcing.

One access control policy description language is XACML (extensible Access Control Markup Language). XAMCL is an XML based language and is very powerful but also very complex and requires both the knowledge of XML in general and the XACML grammar represented by its XML schema in particular. Building a XACML policy is tedious even for an expert. In addition, as for any XML based language, the tag names and domain references rapidly obscure a specification. The use of traditional XML editors (such as XMLPad) or even specialized XACML editors only partly alleviates this problem because a user still needs to have knowledge of the grammar of the XACML language with the relevant tag names. The University of Murcia (UMU) XACML editor takes the tree manipulation approach with the possibility to collapse portions of a tree to enable focusing on a specific element. Also, it separates tree structure display from value display. However, this presentation prevents the possibility of having an overview of a policy and its related rules. This in itself could be a source of errors.

Another factor is that most access control systems are used to protect large enterprises assets thus are traditionally managed by centralized administrators. These administrators are usually well trained programmers and thus have extensive knowledge in writing logical expressions. Naturally, centralization usually translates into a large number of rules to manage that result in inconsistencies mostly due to the lack of appropriate rules management tools that would show to the administrator that a newly introduced rule conflicts with an existing rule.

A number of algorithms and related tools for other access control languages for handling these problems can be found in the literature. However, there are many applications where access control is more decentralized and thus in the hands of users, with some of these users playing the role of administrators and others playing the role of consumers of the service. While centralized administrators for large access control systems have extensive programming skills and logic knowledge, the more isolated users of smaller systems may have limited programming skills, if any at all. However, it is important for these individuals to be able to create access control rules using simpler and more accessible tools while still being able to detect and, more importantly, understand inconsistencies in these rules.

Another factor to be considered is the far ranging consequences of such systems. While the access control systems under consideration are relatively small, these systems potentially reach a large number of individual consumers of a given service provider (such as a bank or a large retail outlet). Errors and problems with the access control system, such as would occur if inconsistencies existed in the rules, would have consequences for the service provider due to decreased consumer confidence in the overall service.

Based on the above noted points, there is therefore a need for systems and methods relating to access control systems that mitigate if not overcome the shortcomings of the prior art. It would be advantageous if inconsistencies, conflicts, and other errors in the rules for an access control system were to be discoverable using such systems and methods.

### SUMMARY OF INVENTION

The present invention provides methods and systems for access control systems such as firewalls. The system detects conflicts between two access control rules by finding all common variables between the two rules and determining if there are values for all the common variables that simultaneously satisfy both rules. If there are such values, and if the end result of the two rules are different (permit against deny effect), then the two rules are in conflict with one another.

In a first aspect, the present invention provides a method of detecting a conflict between two rules, each of said rules having a predetermined end effect, the method comprising:

a) selecting a first specific rule, said first specific rule having a first end result

b) selecting a second specific rule, said second specific rule having a second end result, said second end result being different from said first end result

c) determining all common variables which occur in both of said first and second specific rules

d) for each of said common variables, determining conflict values which satisfy both of said first and second specific rules

e) in the event said conflict values do not exist for at least one of said common variables, determining that said first and second specific rules do not conflict

f) in the event said conflict values exist for all of said common variables, determining that said first and second specific rules conflict with one another.

In a second aspect, the present invention provides a method for determining conflicts between specific firewall rules for use in a data processing system, the method comprising:

a-1) accessing a database of firewall rules

a-2) selecting a first firewall rule having a first outcome

a-3) selecting a second firewall rule having a second outcome, said second outcome being an opposite of said first outcome

a-4) determining if said first and second firewall rules refer to the same protocols

a-5) determining if a first source port interval referred to by said first firewall rule overlaps a second source port interval referred to by said second firewall rule

a-6) determining if a first destination port interval referred to by said first firewall rule overlaps a second destination port interval referred to by said second firewall rule

a-7) determining if a first source IP address range referred to by said first firewall rule overlaps a second source IP address range referred to by said second firewall rule

a-8) determining if a first destination IP address range referred to by said first firewall rule overlaps a second destination IP address range referred to by said second firewall rule

a-9) in the event step d) determines that said first and second firewall rules refer to same protocols and said source port intervals, said destination port intervals, said source IP address ranges, and said destination IP address, determining that said first and second firewall rules are in conflict with one another.

In a third aspect, the present invention provides a system for use in editing or creating access control rules for communications system, the system comprising:
an editing module for allowing a user to either edit pre-existing access control rules or create new access control rules
a retrieval module for retrieving pre-existing access control rules from a database
a conflict detection module for detecting conflicts between pre-existing access control rules returned by said retrieval module and edited access control rules or newly created access control rules from said editing module
a conflict reporting module for reporting any of said conflicts between pre-existing access control rules and edited or newly created access control rules and for reporting details regarding said conflicts to a user.

### BRIEF DESCRIPTION OF THE DRAWINGS

A better understanding of the invention will be obtained by considering the detailed description below, with reference to the following drawings in which:

FIG. 1 is a flowchart illustrating the steps in a method according to one aspect of the invention;

FIG. 2 is a flowchart illustrating the steps in a method according to another aspect of the invention

FIG. 3 is a block diagram illustrating the modules in an XACML system

FIG. 4 is a block diagram illustrating the same system in FIG. 3 with an extra module according to another aspect of the invention

FIGS. 5 to 8 are screenshots from an editor according to one aspect of the invention

FIG. 9 is a block diagram illustrating how a translator module may be used with the system

FIGS. 10, 10A are screenshots from a policy editor according to one aspect of the invention

FIGS. 11 and 12 illustrate reporting screens which indicate the results a conflict check and the reasons for a conflict

FIG. 13 is a block diagram illustrating the modules in a conflict detection subsystem according to one aspect of the invention

FIG. 14 is a block diagram of a variant of the subsystem of FIG. 13 which uses translation modules

FIG. 15 is a flowchart illustrating the steps in a method according to another aspect of the invention for determining if an overlap exists between two intervals

FIG. 16 is a flowchart illustrating the steps in a method according to yet another aspect of the invention for determining an overlap between two IP address ranges

### DETAILED DESCRIPTION OF THE INVENTION

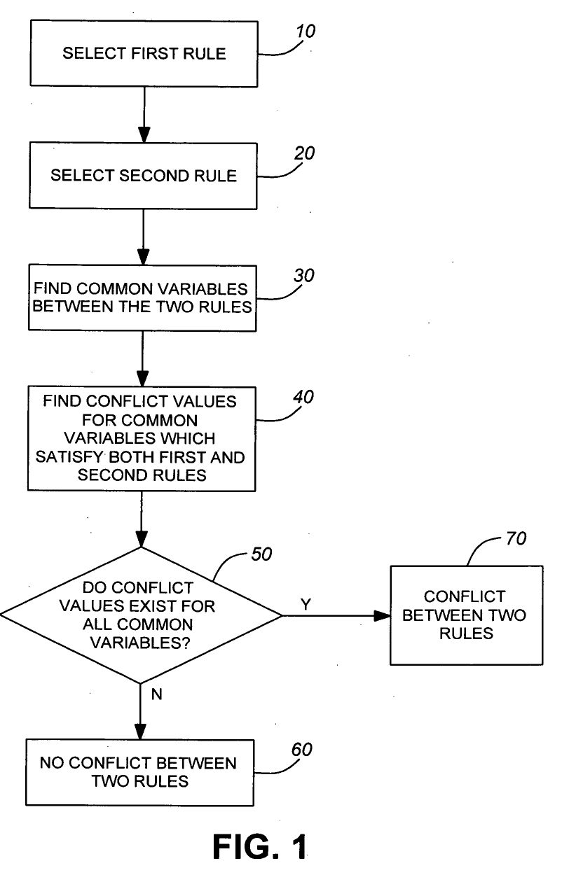

The present invention includes a method for detecting conflicts between two rules. This method is illustrated in the flowchart of FIG. 1. The method will be explained in greater detail below with a specific example of an implementation for firewall rules.

Referring to FIG. 1, the method starts with selecting the first rule (step 10) to be compared. The next step (step 20) is that of selecting the second rule to which the first rule is to be compared with. Once the two rules have been selected, variables common to the two rules are then determined (step 30). With the common variables known, a search (step 40) is then executed to determine if there are conflict values for all the common variables which satisfy both the rules being compared. Thus, for each common variable, the question is whether there are values which satisfy both the first and second rules. The decision step (step 50) determines if, for each of the common variables, there exist such conflict values which satisfy both the rules. If at least one common variable does not have these conflict values, then the result of decision 50 is negative. If, on the other hand, all the common variables have conflict values, then the result of decision 50 is positive. Thus, if the result of the decision 50 is negative, then there is no conflict between the two rules (step 60). Similarly, if the result of the decision 50 is positive, then there is a conflict between the two rules (step 70).

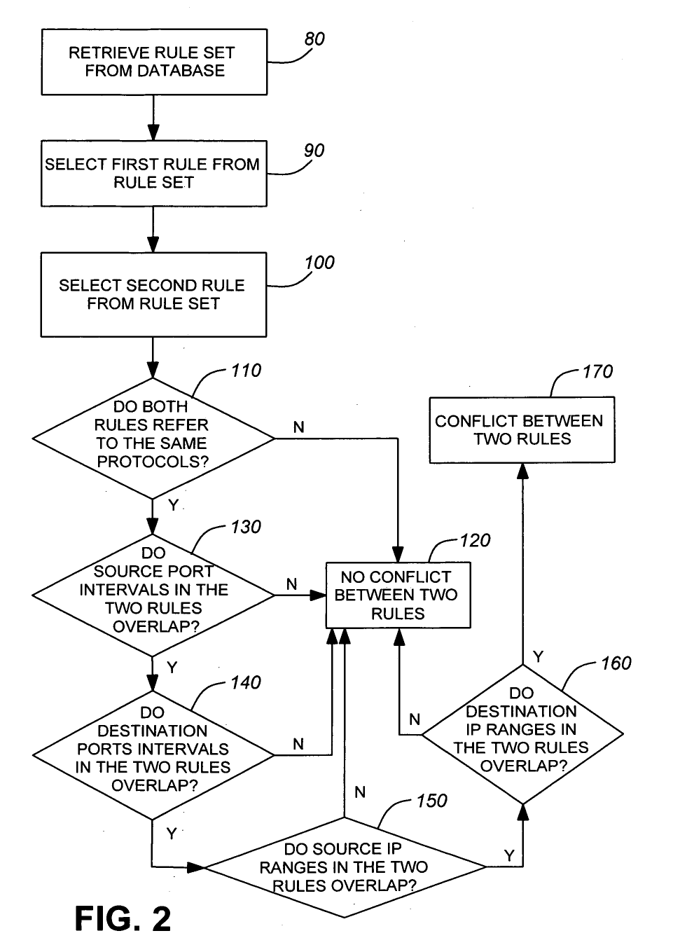

For a firewall implementation of one aspect of the invention, the method used is illustrated in the flowchart of FIG. 2. In this method, two firewall access rules are compared to determine if there is a conflict between them. This method starts with the retrieval of a rule set from a database (step 80). A first rule from the rule set is then selected (step 90). A second rule is then selected from the rule set (step 100). Once the two rules are available, they are then compared with respect to their critical variables. Decision 110 then determines if both of the rules refer to the same protocols. If the two rules do not refer to the same protocols, then there is no conflict between the two rules (step 120). On the other hand, if the two rules do refer to the same protocols, then decision 130 determines if there is an overlap between the source port intervals referred to in the two rules. If there is no overlap, then there is no conflict between the two rules (step 120). If there is an overlap between the source port intervals, then decision 140 determines if destination port intervals referred to by the two rules overlap. Again, if there is no overlap, then there is no conflict between the two rules. If there is an overlap, then decision 150 checks if there is an overlap in the source IP (Internet Protocol) address ranges in the two rules. Again, if there is no overlap, then there is no conflict between the two rules. If there is an overlap, then decision 160 determines if there is an overlap in the destination IP address ranges referred to in the two rules. If there is no overlap in the destination IP address ranges, then there is no conflict (step 120). If there is an overlap, then there is a conflict between the two rules (step 170). As can be seen, to detect a conflict between two firewall rules, the two rules must refer to the same protocols and there must be an overlap in the source port intervals, destination port intervals, source IP address ranges, and destination IP address ranges referred to by the two rules. It should be noted that while the flowchart illustrates the retrieval of a rule set from a database, neither of two rules to be compared for a possible conflict need come from a database.

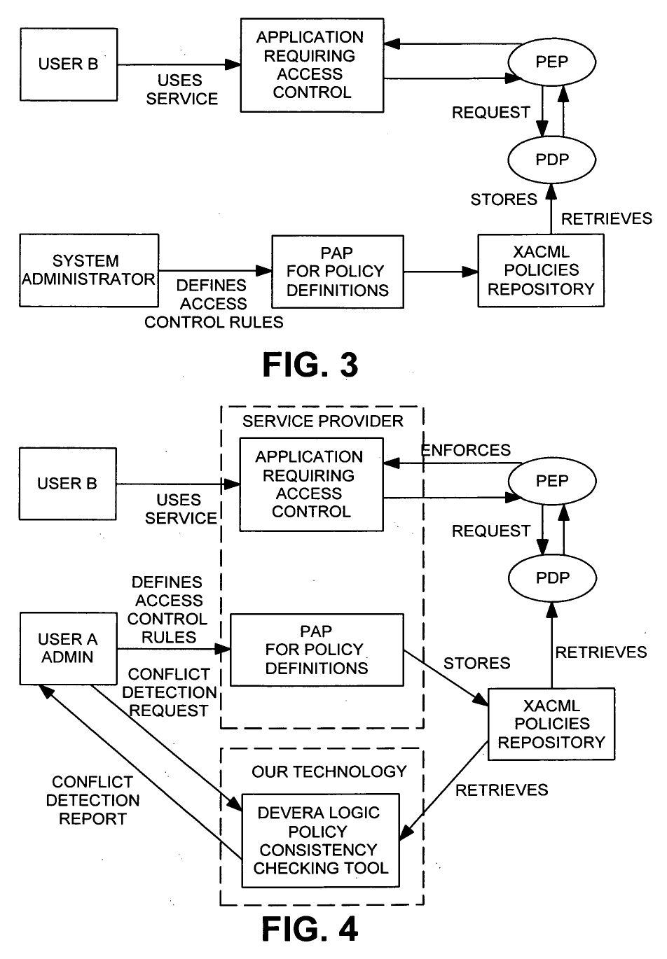

As noted above, XACML is a well-known access control policy description language. For XACML based systems, the base system is that illustrated in FIG. 3. An XACML based access control system is composed of a central rules repository that is accessed both by rule administrators via a Policy Administration Point (PAP) or by any application via a Policy Decision Point (PDP) that is linked to a Policy Enforcement Point (PEP). In such a system, a set of rules written in XML format according to the XACML schema is consulted every time a user places a request to access a protected asset via a Policy Decision Point (PDP) and receives a decision to permit or deny access.

However, one of the central advantages of XACML is that it allows for a rule combining method that enables the determination of which rule to use when several rules match the criteria of a request. This includes two categories: rules that have the same effect and rules with opposite effects. The second category represents the case where the rules conflict. The rule combining method is therefore akin to a “super rule” that favors one of the several rules found. While redundant rules having the same effect are of no consequences on a decision to grant access or not (except perhaps on performance), if two rules with opposite effects conflict, this constitutes a risk. However, this concept of having a rule combining method seems to have been considered as a final solution for the rule conflict problem since little research has been devoted to the subject on conflict detection in XACML policies.

There are several reasons behind this approach. The distributed nature of XACML access control based systems implies that conflicts between rules written by different independent entities are unavoidable. While this simple principle was thought of as an easy solution to conflicts between rule bases that are maintained by several independent entities, it also entices the possibility of severe undesired policy violations that could have severe consequences. The new legal environment (evidenced by legislation such as Sarbanes-Oxley and HIPPA) in which access control systems operate actually make such “super rules” prone to serious litigation. Thus, a conflict detection mechanism becomes very important and quasi unavoidable. For a number of applications, the conflict resolution method constitutes a risk that is not acceptable. This is the case for critical systems such as those that govern access to medical data and financial resources. The consequences of errors in those systems could be threatening to life, limb, and/or financial assets.

One aspect of the present invention is a policy consistency checking tool/subsystem that integrates smoothly in the OASIS/XACML architecture. Referring to FIG. 4, the policy consistency subsystem (a system for detecting conflicts in firewall rules) integrates between the user A and the XACML policies repository. The subsystem may have different components such as an editor module, a conflict detector module, or a conflict reporting module which may be implemented in a client-server configuration without any disruptive impact on existing systems. The subsystem merely accesses the XACML rules repository as shown on FIG. 4.

As noted above, XACML is the most advanced policy description language because it is a standard and thus enables interoperability between various enterprise access control applications. As well, it also makes use of complex logical expressions. However this complexity can also create two classes of problems: it is accessible only to highly skilled users and even for a skilled user it is prone to errors because logic may now lie deeper in complex expressions and thus becomes difficult to spot by a user.

To remedy the issue of complex expressions and the difficulty in spotting logic errors, a novel rule specification notation is introduced below.

Before the introduction of XACML, access control systems programming languages were based on the specification of values or ranges of values for specific variables. For access to be granted or denied depending on the specified effect of the rule, the values of each variable were compared separately until all criteria were met. This separation of variables evaluation in fact implies the principle of conjunctions, i.e. criteria 1 and criteria 2 and . . . and criteria n must match. For example a firewall rule consists in specifying the port numbers, the source and destination IP addresses and the communication protocol, as shown below:

Rule 1 deny UDP port 5000 src ip 1.0.0.1 dst ip 1.0.0.2

Normally, a new rule must be specified for each different combination of criteria. However since this restriction would result in a multitude of rules having to be specified to cover all access control requirements, a way to reduce this rule explosion is to use ranges or list of values to be specified for a given criteria. While this is a radical improvement, a last property somewhat forces people to use another technique that is prone to errors. Only one range per criteria can be specified. This in fact has the effect of only allowing one combination of criteria based on left to right ordering. This forces one to specify two or more rules for disjoint intervals of values such as for example an IP number for two different ranges. This problem is amplified when several criteria are subject to multi-ranges specification. In some cases, it is an advantage to use another technique that consists in using rules of opposite effect (permit/deny) with different breadths of ranges, one rule playing the role of specifying the exception of the broader rule. This technique can be used only with systems where only the first rule encountered in a rule base can be matched. Multiple rules evaluation would irremediably result in conflicts. The following example shows that for a common selection of protocol, source and destination IP number, the effect is to deny access for different destination port number ranges. Note that the examples do not follow CISCO syntax for clarity.
Rule 1 deny UDP src ip 1.0.0.1 dst ip 1.0.0.2 port range (5000-6000)
Rule 2 permit UDP src ip 1.0.0.1 dst ip 1.0.0.2 port range (2000-8000)

Also, another factor in the number of rules that must be specified is the combination of values for different criteria. Due to the fact that individual criteria can only be combined with conjunction operators, cases where there are common values for common criteria cannot be factored out as in the following example:
Rule 1 deny UDP src ip 1.0.0.1 dst ip 1.0.0.2 port 5000
Rule 2 deny TCP src ip 1.0.0.1 dst ip 1.0.0.8 port 7000

Languages like XACML instead allow the use of full logical expressions consisting of natural mixes of conjunctions and disjunctions at any level. This approach enables the reduction of the number of rules to specify and is in a way safer than the opposite effects approach currently used in firewall applications because it places all cases within the same rule where the user can focus on and avoids all of the effects of scattering rules in large rule bases that lead to confusions. However it is to be noted that despite all of the powerful full logical expression features available in XACML, they are rarely used possibly because of the legacy separate variables approaches.

The two above rules can be replaced by a single complex expression based rule as follows:
Rule 1 deny for src ip is 1.0.0.1 and ((UDP for port 5000 and dest ip is 1.0.0.2) or (TCP for port 7000 and dest ip is 1.0.0.8))

In the second approach, the main difference is the order of the criteria which enables some factoring out of for example in this case the src ip address and the use of disjunctions on sub-constraints. XACML is a language that allows full logical expressions to be used in conditions. But the overhead of long tags and domains specification mostly discourage users from using conditions and instead leads them to use only targets or very simple expressions.

While rules based exclusively on conjunctions at the highest level can be represented as a set of values for each criteria in a fixed size table format, rules based on mixes of logical operators need to be represented as logical trees. There are two ways to represent logical expressions:
A textual representation where parenthesis are used to resolve precedence of operators.
A graphic binary tree representation which naturally resolves precedence of operators.

Both these methods are difficult for users that do not have programming skills. The textual representation is also difficult to read and a casual user may not be familiar with bracketing principles or precedence of operators. The same applies to logical trees that are in essence binary trees.

With natural languages, a person would naturally specify rule criteria in some list form with bullets for sub-constrains. The natural indentation of bullets in fact represents a tree. However, the major difference with a binary tree is that indentation does not increase when the criteria in the list pertain to the same item that we would call here a variable.

Based on the above points, it was decided to proceed with a combination of natural language and tree representations that are different from the traditional tree representation methods in two ways:
The natural language component does not use mathematical concepts of grouping with parenthesis and mathematical notation for comparison operators but instead follows natural language.
The tree is not a binary tree but more a tree with natural groupings based on levels and simplified due to the use of natural language. This approach has been made easy by the fact that XACML already has non-binary conjunction and disjunction operators.

The previous example would be represented in a traditional horizontal binary tree with mathematical operators as follows:

Rule 1 effect: Deny

src ip eq 1.0.0.1

and

protocol eq UDP

and

port eq 5000

and

dest ip eq 1.0.0.2,

or

protocol eq TCP

and

port eq 7000

and

dest ip eq 1.0.0.8

This same example is represented with our new tree/natural language notation as follows:

Rule 1 effect: Deny

src ip is 1.0.0.1

and

protocol is one of:
UDP

Provided that port is 5000
Provided that dest ip is 1.0.0.2,

TCP

Provided that port is 7000
Provided that dest ip is 1.0.0.8

The second tree representation is more compact and thus considerably clearer due to the use of a combination of the tree representation and natural language but also due to the handling of disjunctions and the use of the concept of sub-constraints within the disjunctions.

The principle consists of representing the same operator in different ways depending on its level of nesting. The depth of nesting increases from left to right. Thus the top level is always to the left most side and the leaves of the tree at the right most side.

We always represent the top level with a traditional logical operator (and/or). All levels below the top level are represented only with natural language and indentation.

Disjunctions are represented by the variable name, the “is one of” verb and a list of alternate values.

For example the traditional logical expression:

(merchandise equals food) or (merchandise equals clothing)

is represented with our notation as:

merchandise is one of food, clothing

If each of the alternate values is subject to further sub-constraints, each sub-constraint is represented with the verb “provided that”, the variable name, the verb “is” and the value. Several sub-constraints are represented in a kind of bulleted list. The list of sub-constraints really represents a conjunction. It is the use of natural language that implies the conjunction at that level.

It is to be noted that this tree representation is strictly a presentation format. There is a trivial mapping on an internal representation that is a XACML kind of tree. In this application, the XACML like tree internal representation of the rule is used throughout the tool chain.

While the above showed an example where two Cisco firewall rules can be reduced and merged into one rule using logical expressions, the following example shows a reduction from 4 to 1 rule. In fact, any conjunction of disjunctions would in a rigid conjunction only notation like the Cisco firewall rules require a number of rules corresponding to the number of combinations that occur in that expression that are the product of the number of disjunctions in each term of the conjunction and can be calculated as follows:

Number of single rules=nd1× . . . ×ndn

Where nd is the number of disjunctions and the indices indicate the nth term of conjunctions.

For example the single following rule expressed as a single expression with our notation:
Merchandise is one of food, clothing

and
DayOfTheWeek is one of Monday, Wednesday, Friday

would normally be represented by six individual rules in a Cisco like notation:

Rule 1: Merchandise is food and DayOfTheWeek is Monday . . . .

Rule 6: Merchandise is clothing and DayOfTheWeek is Friday

Thus, the use of complex expressions saves potentially a considerable amount of rules and thus reduces the risk of plain errors and conflicts. This leads to the paradox that complexity produces simplicity.

While the above notation allows for complex expressions, its benefits go beyond this ability. Complex expressions save more than number of individual rules. They represent a natural grouping of rules that pertain to a given common combination of sub-criteria. When expressing criteria in a single rule, the user can better focus on the meaning of the combinations of criteria. This natural grouping has another benefit: it avoids scattering of individual rules in a large rule base. Also, the same principle applies to the addition of new rules. Instead of adding a new rule to take into account a new requirement, the user could instead find the broader existing rule that applies to his requirement and merely insert the new requirements into it. This, in a way, forces him to assess the impact of the new requirements on existing rules. Also, the tree/natural language representation in a way forces the user to avoid errors because of the hierarchical ordering of the criteria in the tree. When a user attempts to add sub-constraints at a lower level, an editor can be programmed not to provide criteria from the higher levels of the tree.

Composing rules based on the above notation requires new strategies. The strategy utilized in the editor used in one aspect of the invention is a combination of value selections for each variable through GUIs (graphical user interfaces) and an interactive tree modification principle via the interactive GUI.

The easiest solution for a user-friendly editor is to start with a simple value selection GUI. The first step consists of selecting alternate values for each variable that can itself selected using tabs. Values belonging to the same variable are translated into disjunctions and each variable values selections are combined among each other using conjunction operators. This will result in an expression that is a conjunction between groups of disjunctions of values for a same variable. So far, this is not different from traditional separate variables oriented access control specification languages GUIs.

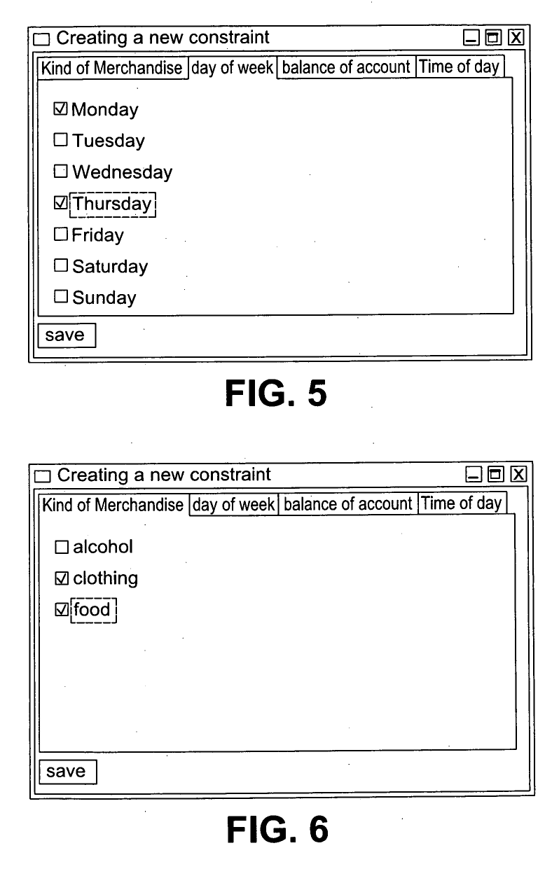

In FIG. 5, a user may have selected the value Monday and Thursday for the variable DayOfTheWeek and food and clothing for the variable Merchandise purchased.

Thus, the user would first click on the day of the week tab and select Monday and Thursday check boxes. Then, after clicking on the kind of merchandise tab, the user would select clothing and food as shown in FIG. 6. This will result in the following tree representation expression to be built:
Day of the week is one of Monday, Thursday

and
Merchandise is one of food, clothing

This method is again designed to avoid having an unskilled user tackle the subtleties of a tree construction from scratch and while at the same time perhaps even mastering the concepts that a tree involves. The approach tries to avoid having the user realize that he is building a tree. Instead, the GUI was designed to break down the process of tree construction into several phases in a manner very similar to how a user would accomplish the same thing using natural language reasoning. This is done by laying down first broad rules of applicability and then refining them as appropriate.

Another factor to be considered is that tree representations have natural overview qualities as long as the number of branches remains low and can be viewed on a single screen. With the mixed tree/textual representation, the overview quality remains high even with complex expressions.

To modify the tree created by the user, the user also uses the GUI. In the first step above, a user would specify all values for criteria that are valid in all cases of his planned rule. In subsequent steps, the user can refine his rule by specifying sub-criteria for each of the original criteria using the remaining variables that were not specified in the first step. Again this is very similar to the behavior of a user using natural language.

To refine the above rule we can insert further constraints to specify time restrictions. In the editor, the user will select one of the values displayed in the tree by highlighting it and then clicking on a number of buttons that allow the modification of the rule for two main purposes:
adding more alternative values for a criteria
adding a sub-constraint to an existing criteria.

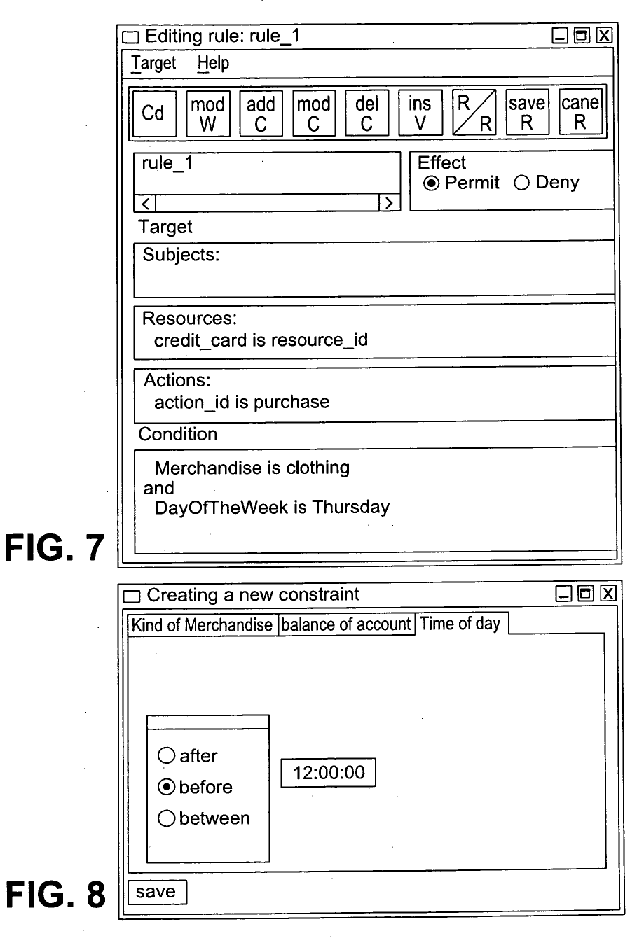

After clicking one of the two modification buttons (either to insert an additional value or to add a constraint), the same GUI for value selection will appear with tabs for each variable except the variable for which the sub-constraint is currently being created. The user will select one of the variable tabs and be presented with either values or ranges selections depending on the data type of the variable. For example, referring to the example in FIG. 7, we may specify that purchasing can be done only in the morning on Thursdays. (See FIG. 7)

After clicking the button for adding a constraint, the user can introduce a time sub-constraint by highlighting the value Thursday of the DayofTheWeek variable and he would be prompted by a new constraint selection widget that allows him to choose from all variables except the variable from the value he has selected (see FIG. 8).

After these modifications the rule tree will now look as follows:

DayOfTheWeek is one of

Thursday

Provided that TimeOfTheDay before 12:00:00

and

Merchandise is one of food, clothing

Our editor has an additional advantage of saving the user from the task of entering either variable names or logical or arithmetic operators. This allows an unskilled user to compose a rule without having to remember variable names and thereby avoiding spelling mistakes that could make the rule unusable and which could generate erroneous decisions when consulted by a PDP.

The rules may be saved in XACML format and, if so, can thus be used by all components of an OASIS access control system that includes the PAP, PEP and PDP. These rules, if saved in XACML format, may also be used by many other kinds of editors such as either XML editors or XACML editors or any reporting tool that understands XACML.

With complex expressions, the commutative nature of logical operators will allow an administrator to specify a rule condition with a different orderings of the criteria.

As an example of the above point regarding complex expressions, the two following rules are fully logically equivalent and would conflict if their effect (permit/deny) would be opposite as is the case here:

Rule_1 (deny) :=

Merchandise is one of food, clothing

and

DayOfTheWeek is one of Monday, Thursday

Rule_2 (permit) :=

Merchandise is clothing

provided that DayOfTheWeek is one of Monday,
Thursday

or

Merchandise is food

provided that DayOfTheWeek is one of Monday,
Thursday

The first rule above is more elegant and avoids the repetition of the DayOfTheWeek criteria. While this case is simple, more complex cases where, for example, the second rule would have two more levels of criteria in the tree and the first rule would remain unchanged, would be much more difficult to spot. The difficulty is due to the increased mental effort required to evaluate the effects. Another factor is that the absence of some criteria in a rule may lead the administrator to overlook their effect. An absent criterion basically means that all the possible values of the criterion domain are satisfied.

Normally, the use of expressions for conditions should prevent users from using the exception rules principle described previously. This in itself should reduce the risk of introducing conflicts. However, natural groupings of multi-criteria rules could still generate conflict situations.

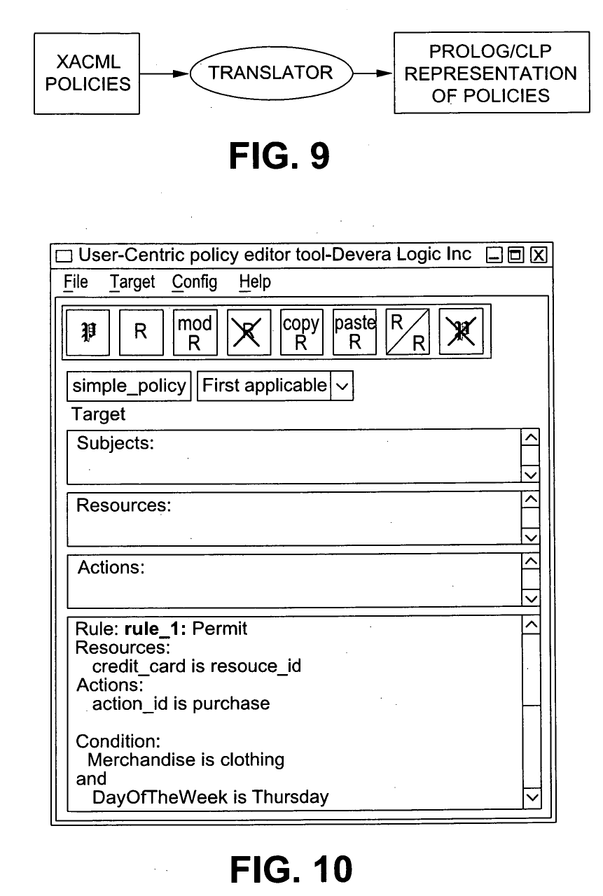

For conflict detection, constraint logic programming techniques may be used. The rules conflict detection is performed using constraint logic programming techniques on a Prolog representation of the rule set of a policy. The present invention provides a transformation of the XACML rule set into a Prolog CLP representation using CLP specific operators. The XACML policies are thereby translated into a Prolog/CLP representation and these are then used for conflict detection purposes (see FIG. 9). For example, the above rule will have the following CLP-Prolog representation:

policy(‘paper_example_1’, ‘permit-overrides’,
....
rule(‘paper_example_1’, ‘rule_1’, ‘Deny’,

variables([variable(‘resource id’, V1),
variable(‘action_id’, V2),
variable(‘Merchandise’, V3),
variable(‘DayOfTheWeek’, V4),
variable(‘TimeOfTheDay’, V5)]

),
target(

subjects([
]),
resources([resource(‘credit_card’ #= V1)
]),
actions([action(‘purchase’ #= V2 )
])

),
condition(((V3 #= ‘clothing’) #\/ (V3 #= ‘food’)) #/\

(((V4 #=‘Monday’) #/\ ( time_less_than(V5, time rep(12,
0, 0)))) #\/ ((V4 #=‘Thursday’) #/\ (
time_greater_than(V5, time_rep(12, 0, 0)))))

)

).

The basic principle of one specific implementation of the invention consists of invoking the Prolog database to retrieve various combinations of pairs of rules with opposite effects. Each pair of rules is then processed to detect a potential conflict among them.

Thus the overall structure of the conflict detection mechanism is implemented in Prolog as follows:

detect_conflicts:-

rule(P, RN1, ‘Permit’, variables(VL1) , T1,
condition(C1)),
rule(P, RN2, ‘Deny’, variables(VL2), T2,
condition(C2)),
detect_conflict_pair(P, STR, variables(VL),

rule(P, RN1, ‘Permit’, variables(VL1), T1,
condition(C1)),
rule(P, RN2, ‘Deny’, variables(VL2), T2,
condition(C2))),

fail.

detect_conflicts.

The conflict detection principle uses the well known CLP principle of constraints satisfaction. For example, when querying the Prolog/CLP engine on the following pair of constraints on the variable X:

?-X#>5, X#<10.

The CLP/Prolog engine will automatically find all the values of the variable X that satisfy both constraints without any further programming.

The Prolog/CLP engine would answer with the values ranging from 6 to 9 that satisfy both constraints:

X=_G285{6 . . . 9}

In the case of access control rules, if two rules of opposite effect of permit and deny are satisfied by a set of common values for all of its variables, there is therefore a conflict.

In order to make the CLP principle work with XACML rules we need a method to enable the unification of an unlimited number of variables since rules do not necessarily always use all the variables available in a rule base. This is achieved via the variables declaration clause in the Prolog representation of the rule base. These declarations consist of a label and a Prolog variable that follows Prolog syntax of using an upper case character as its first character as shown in the example below.

variable(‘Merchandise’, V3)

This then allows us to pick a variable from the variables set of one rule, perform a look up on the variables set of the second rule using the labels, and once found, perform the Prolog unification on the variables. Once this process has been performed for all variables found in a rule, CLP can perform its constraint satisfaction method without further coding on the user's part.

Most research on conflict detection for non XACML languages have focused on various techniques to ensure scalability. With XACML, scalability is partly facilitated by the separation of policies and rules between the target and the condition. Targets are usually designed to be simple and thus do not require complex expression evaluation. Also, if the simple targets of two rules that are compared do not match, the evaluation of the conditions is skipped altogether. Another factor for scalability is the use of Prolog unification. Unification is different from value substitution because it merely changes a value in a point of reference. Finally, once unified, expressions are evaluated on the principle that if any comparison of a sub-expression fails, the comparison between the expressions immediately stops and the result false is merely returned. Thus, there is no real difference in performance between the evaluation of complex expressions and the evaluation of separate components of the separate variables rules specification approach. For both approaches, performance is dependent on the depths for single complex expressions or rank for separate variables comparisons. It is practically impossible to evaluate the real performance of systems proposed in literature because each author uses a different rule base. For example, the amount of computation needed for rule comparisons would depend if the critical difference occurs at the beginning or the end of a list of variables for separate variable rules. Rules that differ on the first variables will require less processing than rules that differ on their last variable in such cases. The processing time will depend directly upon how many other variables must be evaluated before two variable values differ.

As already indicated, the conflict detection method explained above operates on a Prolog representation of a rule base. This in fact implies that its link to XACML is not essential. It could perform conflict detection on any kind of rule base as long as a translator to the internal Prolog representation is made available. The method focuses on performing conflict detection on complex expressions.

The conflict detection method, as implemented using Prolog, may be integrated in an editor as a library. A button in the GUI launches the various steps for the preparation of data to the conflict detection algorithm. There are three steps:
Translate the internal representation of a rule set into a raw Prolog/CLP representation.
Generate variable definitions.
Convert the raw Prolog/CLP rules using the generated variable definitions by substituting each variable name by its Prolog variable equivalent.
Perform the conflict detection algorithm.
Display results.

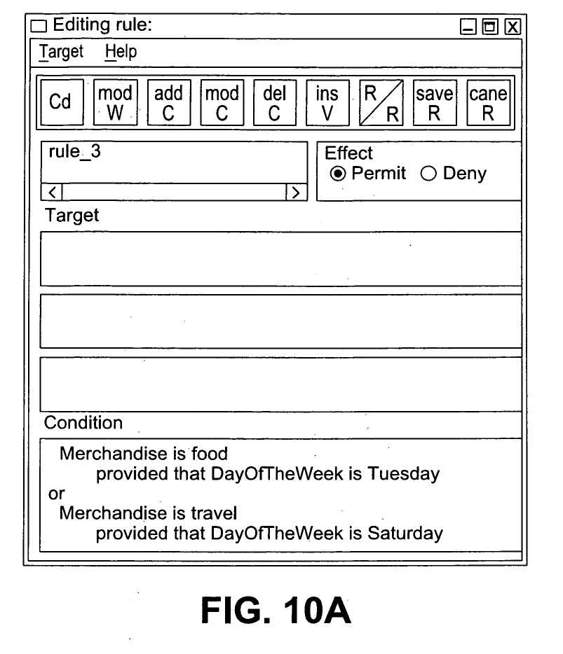

The editor's main window (see FIG. 10) allows one to define the policy characteristics such as the name and the rule combining method. It also allows users to view the elements of the target of the policy along with the list of rules with their conditions in the rule window. Furthermore, it also allows users to initiate other activities that will invoke other editors that will allow:
the creation of a target by selecting the appropriate target menu item among the choices of creating a new subject, resources or action.

The creation of a new rule or the modification of an existing rule by invoking the rule editor.

To edit rules, the rule editor is invoked from the policy editor either by pressing the new rule creation button or by selecting an existing rule in the list. It is composed of the rule characteristics such as its name, effect, the target elements, subject, resource, action, and the condition of the rule. The condition of the rule is displayed using the above noted novel notation. (See FIG. 7)

The rule editor allows the construction of a new condition or the modification of an existing condition in an interactive way.

A new condition can be constructed by pressing button for creating a condition. This will trigger the presentation of a value selection window that presents the different values available for different variables that are present in an application configuration file. (see FIGS. 5 and 6)

A condition may be modified in one of three ways:
Inserting an additional value for a given variable
Deleting a value for a given variable
Inserting a new sub-constraint on a different variable

All modifications are based on a graphical interaction by clicking a word in the current condition and then selecting one of the buttons that correspond to one of the desired modification kinds. (See FIG. 10A)

When a conflict has been detected, the system (perhaps through the editor) provides explanations of the conflict by displaying the values for which there is a conflict in two different ways:

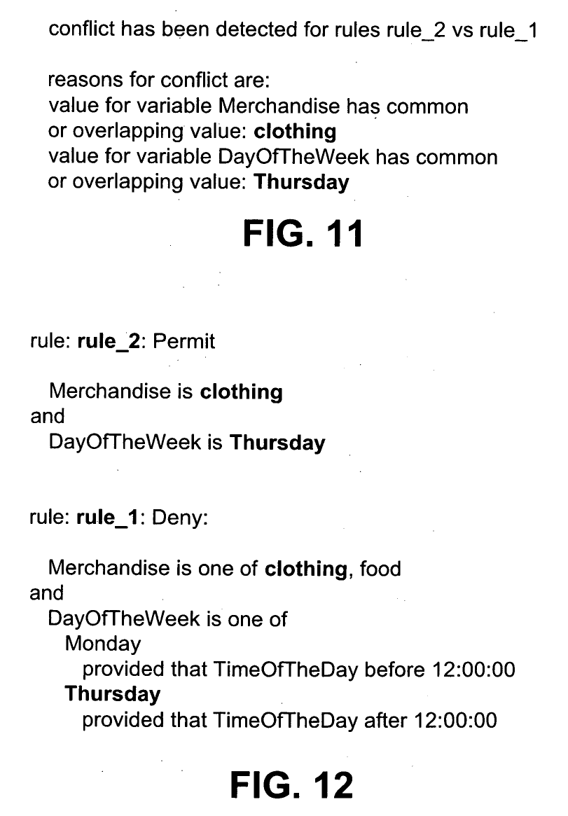

First, a listing displaying the values which can be either discrete values or ranges of values for which there is a conflict is shown. This is a direct benefit of using an expert system and Prolog/CLP in particular because a Prolog/CLP query returns the values that have satisfied the rules as shown in FIG. 11.

Second, the actual conditions regarding the pair of rules that are in conflict are displayed by first displaying these conditions and then highlighting the values that have satisfied both conditions (see FIG. 12). This approach allows the visualization of which branch of a disjunction is causing the conflict.

Regarding the storing of the rules, all rules created with the editor as explained above are stored in XACML format so as to ensure full integration in any XACML based system. For example the above created rule will be stored as follows. There is a trivial translation between the novel notation noted above and XACML targets conditions. For example, logical operators and or or are represented by a XACML function Apply tag as follows:

<Condition
FunctionId=“urn:oasis:names:tc:xacml:1.0:function:and”>

<Apply

FunctionId=“urn:oasis:names:tc:xacml:1.0:function:or”>

Type specific operators are always converted to the corresponding XACML equivalent. Here, since Prolog is a typeless language, an attribute is used in Prolog representation to remember the exact external type.

For example, the comparison for a string would be translated into the following form:

<Apply
FunctionId=“urn:oasis:names:tc:xacml:1.0:function:string
-equal”>

<Apply

FunctionId=“urn:oasis:names:tc:xacml:1.0:function:string
-one-and-only”>

<SubjectAttributeDesignator

AttributeId=“Merchandise”
DataType=“http://www.w3.org/2001/XMLSchema#string” />

</Apply>
<AttributeValue

DataType=http://www.w3.org/2001/XMLSchema#string>cloth

ing</AttributeValue>
</Apply>

The comparison of a time value would instead use the XACML time type:

<AttributeValue
DataType=http://www.w3.org/2001/XMLSchema#time>12:00:00<
/AttributeValue>

This strategy enables full interoperability with other external XACML based tools, such as editors, PAPs, PDPs, PEPs or any other analysis tool available on the market.

It should be noted that the storing of the rules in the XACML language is not necessary for the purpose of conflict detection. The rules could be stored directly into the Prolog/CLP language. Currently, for the purpose of conflict detection, all the rules in a rule set are stored in memory for fast access. However, other solutions for very large rule sets use external storage. Thus the size of the rule base is not a factor.

As well, it should be noted that the rules may be stored in any format as long as a translator module is present to translate the rules into a format that a conflict detection module can use. In one implementation, the format is, as explained above, that used by the Prolog/CLP language.

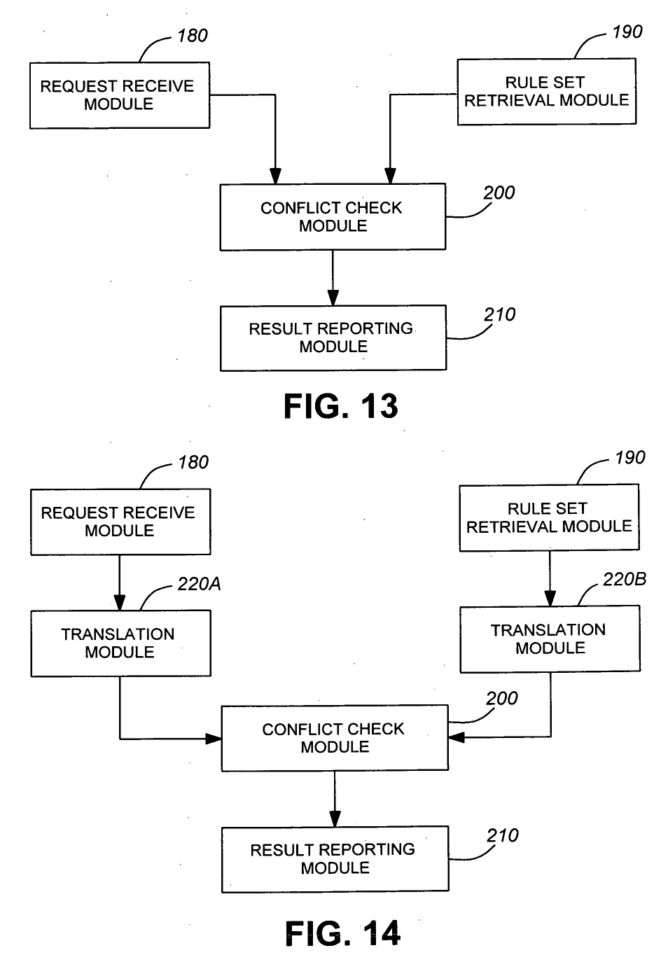

Referring to FIG. 13, a block diagram of a module map for a conflict detection subsystem is illustrated. A request receive module 180 receives requests for a conflict check and may also receive one of the rules to be checked. A rule set retrieval module 190 is for accessing a database of rules or policies (such as the XACML policies repository) and for retrieving the relevant rule set. The relevant rule set and the rule to be checked are received by the conflict check module that actually performs the conflict checking by executing the methods as explained above and below. The results of the conflict check are then passed on to the result reporting module 210 for reporting to the user.

Referring to FIG. 14, a variant of the subsystem of FIG. 13 is illustrated. The variant in FIG. 14 has the same modules as FIG. 13 with the difference that two translation modules 220A and 220B are present.

Translation module 220A receives the output of the request receive module 180 and translates it into a format usable by the conflict check module 200.

Similarly, translation module 220B receives the output of the rule set retrieval module 190 and translates it into a format usable by the conflict check module 200.

It should be noted that the two translation modules 220A and 220B need not be the same as the rule set format may be different from the format used by the request receive module. Using this approach, differently formatted rules may be checked for conflicts, as long as the relevant translation modules translate the rules into a format usable by the conflict check module.

Regarding FIGS. 13 and 14, while only one rule set retrieval module is illustrated in these figures, multiple rule retrieval set modules may be used. As an example, if the two rules being compared are from different rules sets from different databases, then two of these retrieval modules may be used, with one retrieval module for each rule set being retrieved.

Similarly, while multiple rule set retrieval modules may be used, it is also possible to use a single rule retrieval set module to retrieve multiple modules from different databases.

It should be noted that, for a firewall rules implementation of the invention, specific methods for detecting overlaps in the variables contained in firewall rules need to be defined. As explained above, one aspect of the invention is a generalized method for detecting conflicts between rules and which involves determining all common variables between the rules being compared. Then, once all the common variables have been found, conflict values for each variable, values which satisfy both rules, can be found. Once conflict values have been found for all the common variables, then a conflict can be declared. Of course, if conflict values cannot be found for all common variables, then the rules do not conflict.

For firewall rules, six fields or variables are generally used:
(i) An action (permit or deny access)
(ii) A protocol (such as TCP)
(iii) An interval of source ports
(iv) An interval of destination ports
(v) A range of source IP addresses
(vi) A range of destination IP addresses

Thus, to compare two firewall rules, each rule must be examined for each of the six variables or fields noted above.

To ensure that no duplication of effort is performed, pairs of rules are matched from the available rules. This is especially useful for detecting any underlying or deeply buried conflicts in a rule set. This is done by separating the rule set into two sets—one set for rules that have a PERMIT effect and one set for rules that have a DENY effect. Then, one rule from the PERMIT set is selected and this is matched with all the rules from the DENY set. The next rule from the PERMIT set is then matched with all of the rules from the DENY set and so on and so forth. This continues until all the rules in the PERMIT set has been matched with all of the rules from the DENY set. This approach ensures that all pairs of rules have one rule with a PERMIT effect and one rule with a DENY effect. Each pair is then checked for a conflict.

It should be noted that, while firewall rules generally have a PERMIT effect or a DENY effect, the above approach also works for effects that are not diametrically opposed to one another. As such, if rule A has effect A1 and rule B has effect B1, as long as the effect A1 is not the same as effect B1, the rules A and B may be matched in a pair to determine if they conflict. (For this case, it is possible that effects A1 and B1 do not affect one another). Preferably, of course, the end result (or effect) of one rule in a rule pair to be compared is opposite the end result (or effect) of the other rule in the rule pair.

Once the rule pairs have been found, the first firewall rule in each pair is evaluated against the second firewall rule. The two firewall rules are in conflict if and only if:
the action of one rule is permit and the action of the other rule is deny,
the protocols referred to by the two rules are the same,
there is an overlap in the source port intervals of the two rules,
there is an overlap in the destination port intervals
there is an overlap in the source IP address ranges, and
there is an overlap in the destination IP address ranges.

To check if the above conditions hold true, the method illustrated in FIG. 2 is executed. As can be seen from FIG. 2, in the event any of the five variables (protocols, source port intervals, destination port intervals, source IP address ranges, and destination IP address ranges) do not overlap, there is no conflict between the two rules. It should be noted that FIG. 2 assumes that the two rules being compared have different end results or effects.

It should be noted that this method of detecting conflicts between firewall rules has been formally verified by the inventors. The inventors have mathematically proven (using the computer-assisted theorem proving system Coq) that the above method detects all pairs of rules having opposite actions that are in conflict. As noted before, two rules are in conflict if and only if there exists some request (or dataset) that matches both rules and the action of one rule is PERMIT and the action of the other rule is DENY.

To determine if there is an overlap in the port intervals, one must first realize that each interval has two endpoints, x and y. It can be assumed that x<y. Thus, a first interval can be represented as (x₁,y₁) and a second interval can be represented as (x₂, y₂). There is an overlap between the two intervals if both these conditions are true

x₁<y₂ (i)

x₂<y₁ (ii)

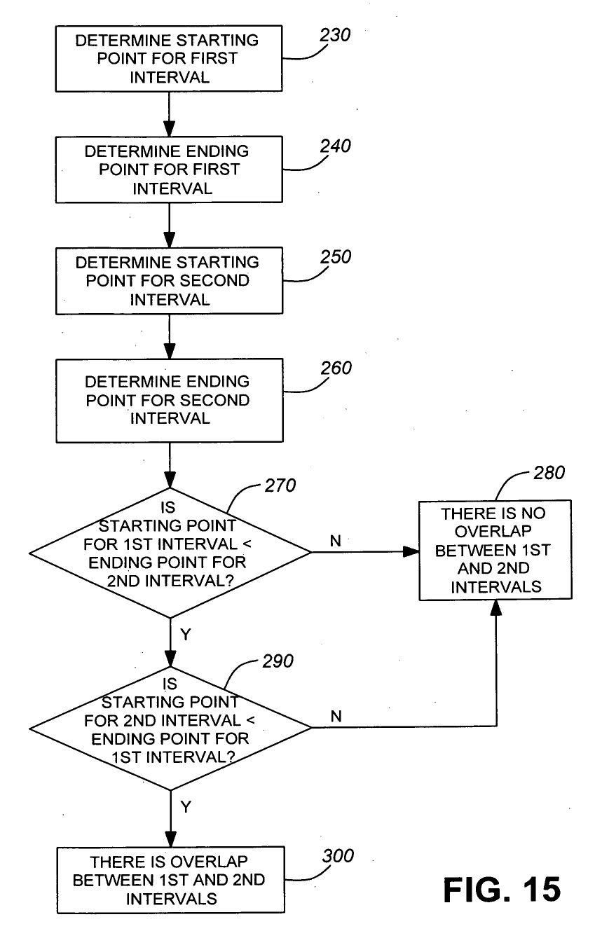

The method executed to determine overlap between two intervals is illustrated in FIG. 15. The method begins with determining the starting point and ending point for the first interval (steps 230, 240). The starting point and the ending point of the second interval are then determined (steps 250, 260). Decision 270 then determines if the starting point for the first interval is less than the ending point for the second interval. If decision 270 has a negative result, then there is no overlap between the two intervals (step 280). If the decision 270 has a positive result, then decision 290 then determines if the starting point for the second interval is less than the ending point of the first interval. Again, if the result of decision 290 is negative, then there is no overlap between the two intervals (step 280). If the result of decision 290 is positive, then there is an overlap between the two intervals (step 300).

With respect to IP address ranges, determining overlap between two IP address ranges requires a different approach. Ranges are not simple intervals as in the case of port numbers but are given by a base address and a bit mask. The bit mask specifies which bits of the base address are to be considered variable and which ones are to be considered fixed. This can be explained further with a more detailed example. As an example, if the base address is (ip 140 101 171 31) and the mask is (ip 24 7 56 255), then, writing them in binary form in the first two lines, we get the matching pattern in the third line of the following scheme:
base: 10001100.01100101.10101011.00011111
mask: 00011000.00000111.00111000.11111111
pattern: 100**100.01100***.10***011.********

This shows that the matching addresses must have the same bit values as the base in the positions where the mask has a 0, and can have any value in the positions where the mask has a 1. In practice this system is used to define simple intervals by having a mask with all 0s in the higher positions and all is in the lower positions. One of the common errors in defining access rules is to provide an incorrect mask, thus specifying unintended addresses.

To determine if two IP addresses overlap, we must consider each of the bit positions (however many there are) in the base addresses and masks of both IP addresses. For a particular bit, there is a match if and only if the bit in either mask is 1 or if the bit in the base address of the first IP address is the same as the bit in the base of the second IP address. Two IP addresses overlap exactly when there is a match at every bit.

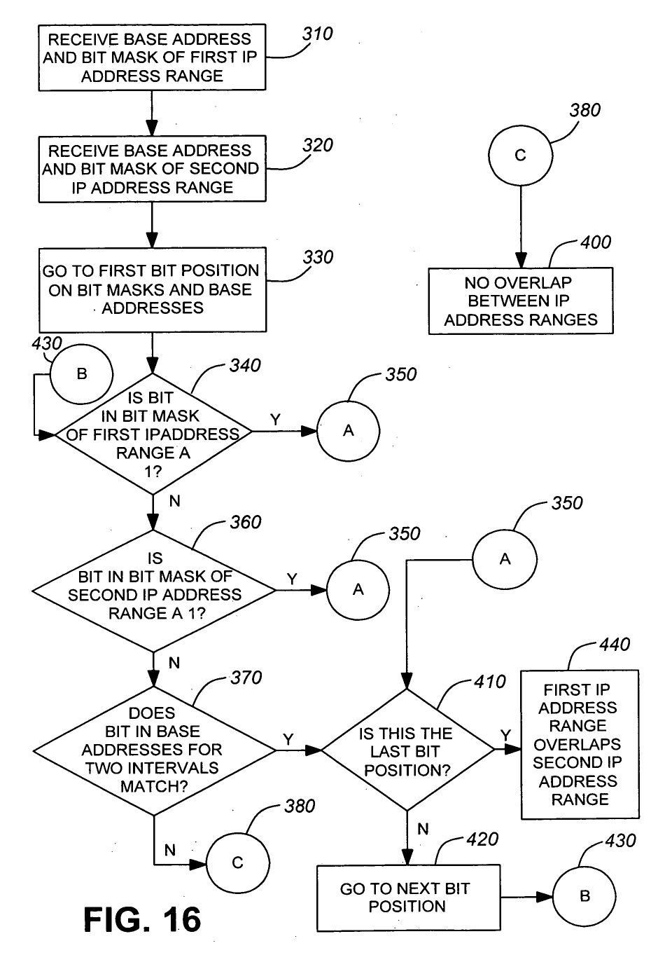

The method used to determine if an overlap exists between two IP address ranges is illustrated in FIG. 16. The method starts in step 310 with the reception of the base address and bit mask of the first IP address range. Step 320 receives the base address and bit mask of the second IP address range. For step 330, the first bit position in the bit masks and base addresses are examined. A logical loop is then entered which, if completed, examines all the bit positions. Decision 340 then determines if the bit in the bit mask of the first IP address range is a 1. If so, then connector A (step 350) breaks out of the loop. If the result of decision 340 is negative, then decision 360 determines if the bit in the bit mask of the second IP address range is a 1. If the result is positive, then connector A (step 350) again breaks out of the logical loop. If the result is negative, then decision 370 checks if the relevant bit in the base addresses of the two IP address ranges match one another. If the result of decision 370 is negative, then connector 380 breaks out of the logical loop and a conclusion is reached that there is no overlap between the two IP address ranges (step 400). If the result of decision 370 is positive, then decision 410 determines if the bit position being examined is the last bit position. If it is not the last bit position, then step 420 is that of moving to the next bit position. Connector 430 then moves the logic back to decision 340. It should be noted that connector A (step 350) that broke out of the logical loop reenters the method at decision 410. If the result of decision 410 is positive, then the conclusion that the two IP address ranges overlap is reached (step 440).

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method of detecting a conflict between two rules, each of said rules having a predetermined end result, the method comprising
a) selecting a first specific rule, said first specific rule having a first end result
b) selecting a second specific rule, said second specific rule having a second end result, said second end result being different from said first end result
c) determining all common variables which occur in both of said first and second specific rules
d) for each of said common variables, determining conflict values which satisfy both of said first and second specific rules
e) in the event said conflict values do not exist for at least one of said common variables, determining that said first and second specific rules do not conflict
f) in the event said conflict values exist for all of said common variables, determining that said first and second specific rules conflict with one another.

2. A method according to claim 1 wherein said first end result is opposite to said second end result.

3. A method according to claim 1 wherein at least one of said first specific rule and said second specific rule is part of a rule set.

4. A method according to 3 wherein said rule set is for controlling access to a communications system.

5. A method according to claim 4 wherein step d) comprises determining if an overlap occurs between a first range of values referred to by said first specific rule and a second range of values referred to by said second specific rule.

6. A method according to claim 4 wherein step d) comprises determining if an overlap occurs between a first interval referred to by said first specific rule and a second interval referred to by said second specific rule.

7. A method for determining conflicts between specific firewall rules for use in a data processing system, the method comprising:
a-1) accessing a database of firewall rules
a-2) selecting a first firewall rule having a first outcome
a-3) selecting a second firewall rule having a second outcome, said second outcome being an opposite of said first outcome
a-4) determining if said first and second firewall rules refer to the same protocols
a-5) determining if a first source port interval referred to by said first firewall rule overlaps a second source port interval referred to by said second firewall rule
a-6) determining if a first destination port interval referred to by said first firewall rule overlaps a second destination port interval referred to by said second firewall rule
a-7) determining if a first source IP address range referred to by said first firewall rule overlaps a second source IP address range referred to by said second firewall rule
a-8) determining if a first destination IP address range referred to by said first firewall rule overlaps a second destination IP address range referred to by said second firewall rule
a-9) in the event step d) determines that said first and second firewall rules refer to same protocols and said source port intervals, said destination port intervals, said source IP address ranges, and said destination IP address, determining that said first and second firewall rules are in conflict with one another.

8. A method according to claim 7 wherein said steps of determining if an overlap exists between two intervals comprises:
b-1) determining a first starting endpoint for a first interval
b-2) determining a first ending endpoint for said first interval, said first starting endpoint being smaller in value than said first ending endpoint
b-3) determining a second starting endpoint for a second interval
b-4) determining a second ending endpoint for said second interval, said second starting endpoint being smaller in value than said second ending endpoint
b-5) determining if a first condition is logically true, said first condition being whether said first starting endpoint is smaller in value than said second ending endpoint
b-6) determining if a second condition is logically true, said second condition being whether said second starting endpoint is smaller in value than said first ending endpoint
b-7) determining that said first interval overlaps said second interval if both of said first and second conditions are logically true.

9. A method according to claim 7 wherein each of said IP address ranges is represented by a binary base address and a binary bit mask and wherein said steps of determining if an overlap exists between two IP address ranges comprises:
c1) receiving a first IP address range with a first binary base address and a first binary bit mask
c2) receiving a second IP address range with a second binary base address and a second binary bit mask
c3) for each bit position in said binary base addresses and said binary bit masks, performing the following steps
c3-1) determining if a mask condition is logically true, said mask condition being whether either said first binary bit mask or said second binary bit mask is a 1 in said bit position
c3-2) determining if a base condition is logically true, said base condition being whether said first binary base address matches said second binary base address at said bit position
c4) determining that said first IP address range overlaps said second IP address range if either said mask condition or said base condition is logically true for all bit positions in said binary base addresses and said binary bit masks.

10. A method according to claim 7 further including step
a-10) in the event of conflict between said first firewall rule and said second firewall rule, reporting said conflict and a reason for said conflict to a user, said reason being derived from any of said overlaps determined in steps a-5), a-6), a-8), and common protocols determined in step a-4).

11. A system for use in editing or creating access control rules for communications system, the system comprising:
an editing module for allowing a user to either edit preexisting access control rules or create new access control rules
a retrieval module for retrieving preexisting access control rules from a database
a conflict detection module for detecting conflicts between preexisting access control rules returned by said retrieval module and edited access control rules or newly created access control rules from said editing module
a conflict reporting module for reporting any of said conflicts between preexisting access control rules and edited or newly created access control rules and for reporting details regarding said conflicts to a user.

12. A system according to claim 11 further including
a translator module for receiving retrieved preexisting access control rules and translating said preexisting access control rules into a format usable by said conflict detection module

13. A system according to claim 11 wherein said editing module provides said user with a GUI for editing preexisting access control rules or creating new access control rules

14. A system according to claim 11 wherein said conflict detection module has computer readable instruction which, when executed, implements a method of detecting a conflict between two rules, each of said rules having a predetermined end result, the method comprising:
a) selecting a first specific rule, said first specific rule having a first end result
b) selecting a second specific rule, said second specific rule having a second end result, said second end result being different from said first end result
c) determining all common variables which occur in both of said first and second specific rules
d) for each of said common variables, determining conflict values which satisfy both of said first and second specific rules
e) in the event said conflict values do not exist for at least one of said common variables, determining that said first and second specific rules do not conflict
f) in the event said conflict values exist for all of said common variables, determining that said first and second specific rules conflict with one another.

15. A system according to claim 11 wherein said conflict detection module has computer readable instructions which, when executed, implements a method for determining conflicts between specific firewall rules, the method comprising:
a-1) accessing a database of firewall rules
a-2) selecting a first firewall rule having a first outcome
a-3) selecting a second firewall rule having a second outcome, said second outcome being an opposite of said first outcome
a-4) determining if said first and second firewall rules refer to the same protocols
a-5) determining if a first source port interval referred to by said first firewall rule overlaps a second source port interval referred to by said second firewall rule
a-6) determining if a first destination port interval referred to by said first firewall rule overlaps a second destination port interval referred to by said second firewall rule
a-7) determining if a first source IP address range referred to by said first firewall rule overlaps a second source IP address range referred to by said second firewall rule
a-8) determining if a first destination IP address range referred to by said first firewall rule overlaps a second destination IP address range referred to by said second firewall rule
a-9) in the event step d) determines that said first and second firewall rules refer to same protocols and said source port intervals, said destination port intervals, said source IP address ranges, and said destination IP address, determining that said first and second firewall rules are in conflict with one another.

16. A system according to claim 15 wherein said steps of determining if an overlap exists between two intervals comprises:
b-1) determining a first starting endpoint for a first interval
b-2) determining a first ending endpoint for said first interval, said first starting endpoint being smaller in value than said first ending endpoint
b-3) determining a second starting endpoint for a second interval
b-4) determining a second ending endpoint for said second interval, said second starting endpoint being smaller in value than said second ending endpoint
b-5) determining if a first condition is logically true, said first condition being whether said first starting endpoint is smaller in value than said second ending endpoint
b-6) determining if a second condition is logically true, said second condition being whether said second starting endpoint is smaller in value than said first ending endpoint
b-7) determining that said first interval overlaps said second interval if both of said first and second conditions are logically true.

17. A system according to claim 15 wherein each of said IP address ranges is represented by a binary base address and a binary bit mask and wherein said steps of determining if an overlap exists between two IP address ranges comprises:
c1) receiving a first IP address range with a first binary base address and a first binary bit mask
c2) receiving a second IP address range with a second binary base address and a second binary bit mask
c3) for each bit position in said binary base addresses and said binary bit masks, performing the following steps
c3-1) determining if a mask condition is logically true, said mask condition being whether either said first binary bit mask or said second binary bit mask is a 1 in said bit position
c3-2) determining if a base condition is logically true, said base condition being whether said first binary base address matches said second binary base address at said bit position
c4) determining that said first IP address range overlaps said second IP address range if either said mask condition or said base condition is logically true for all bit positions in said binary base addresses and said binary bit masks.

18. A system according to claim 15 wherein said method further includes step
a-10) in the event of conflict between said first firewall rule and said second firewall rule, reporting said conflict and a reason for said conflict to a user, said reason being derived from any of said overlaps determined in steps a-5), a-6), a-8), and common protocols determined in step a-4), said reporting being done through said conflict reporting module.
